(19) United States
(12) Patent Application Publication
(10) Pub. No.: US 2006/0149560 A1
(43) Pub. Date: Jul. 6, 2006

(54) Business application generation system

(76) Inventors: Georg Podhajsky, Philippsburg (DE); Joem Rischmueller, Nussloch (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/525,732

(22) PCT Filed: Aug. 30, 2002
(86) PCT No.: PCT/EP02/09671

§ 371 Date: Feb. 3, 2006

(51) Int. Cl. G06Q 99/00

(52) U.S. Cl. 705/1

(57) ABSTRACT

Systems and methods are disclosed for generating a business software application. In one embodiment, a business application generation system for automatically generating a business software application is provided. The business application generation system may include a central processing unit, a repository containing a set of meta data, a generation tool, and input/output means for treating the meta data and for invoking the generation tool. The set of meta data may contain structured business process application information. Further, the generation tool may retrieve data from the repository and, on the basis of the retrieved repository data, generate a customized business process application.

### TECHNICAL FIELD

The technical field of this invention is in the area of the generation of software application. More particularly, the invention relates to methods, computer program products and systems to generate a business software application to be used in the field of commercial business processes such as billing processes, bonus payment processes, incentive and other human resource budget processes and other business processes that involve accumulating or debiting steps.

### BACKGROUND

In today's commercial world, software applications render a lot of business processes very convenient. One of these business processes, for example, is the process of billing, i.e. the creation of bills for services rendered and/or goods delivered. In order to facilitate and automate the billing process, software applications exist that enable the user of such a software application to create bills on the basis of a data input to the system on which the software is run. However, instead of inputting the data into the system, it would be much more convenient to be able to use data that already exists in the business software of the user, i.e. data relating to a certain order of a certain client. Although such billing software applications that automatically retrieve relevant data from the business application exist, the existing applications are especially conceived for specific business applications and for specific billing needs, leading to a divergence in the area of billings software applications. However, in today's global business world, it becomes more and more important for a company to be able to react and adapt quickly to new business models and improve customer services to compete effectively. Therefore, there is a requirement for modern billing processes as to system openness, flexibility, and customer relation that cannot be met with the existing billing software applications.

### SUMMARY

It is therefore an object of the present is invention to provide for a system and a method which permit to overcome the drawbacks of existing business software applications.

The present invention provides a business engine application generation system for automatically generating a business software application which allows to generate a customized business application on the basis of a predefined set of meta data provided in a repository of the system according to the invention. Said set of predefined meta data contains structured information relating to business processes, the predefined meta data being adaptable via input/output means to the specific needs of the applications to be generated. Particularly, the set of meta data is adaptable as to the business solution providing the customer and business process data but also to specific business process requirements, such as customer requirements.

According to the invention, this is achieved by using a generation tool which, on the basis of the set of meta data, generates a customized application which is called a business engine application.

This business engine application enables a user to group, price, and merge data from all source applications into a single invoice or item. The business engine application can output invoices etc. in various media such as printer, fax, e-mail, or external output management systems, and particularly to various accounting applications. Because of its flexible architecture, the system according to the invention helps to adapt quickly to new business models, such as the billing of product bundles from various industry sectors or invoicing for third-party services. A big advantage of the invention is that it enables to generate a business application tailored to meet specific business needs, the options being quickly and easily changeable.

Advantageously, the generation tool comprises a first generator and a second generator, said first generator being a meta data dependent generator and said second generator being a meta data independent generator. For each generation relevant object, the first generator contains a function group and the second generator contains a function.

The set of meta data according to the invention consists of data base tables containing meta data entities. These entities contain information on the identification of an application to be generated, on object types and on object structures. Thus, the meta data of the repository are structured into entities, the entities containing attributes describing concrete or abstract unities of a data model forming the basis for the generation process.

The system according to the invention further comprises as input/output means a workbench which enables a user treatment of the meta data of the repository, i.e. the viewing, creating, adding, deleting, changing, inheriting, editing etc. said meta data. The workbench also enables a user to invoke or start the generation process which is done by initiating an import of meta data into the generation tool, and more precisely into the first generator of the generation tool.

In the generation process according to the invention, the generation tool generates a customized business software application on the basis of meta data altered by a user in view of specific needs, by joining function groups generated by the first generator with functions and code generated by the second generator.

Thus, the invention provides for a business application generation system for automatically generating a business software application which constitutes a convergent approach as it is able to process business process data from various source applications, thus “converging” different business process streams, and meeting company-specific, industry-specific, country-specific and tax-specific requirements.

The invention further provides for a business application generation which enables a user to automatically adapt a business software application to different needs and requirements by automatically generating an adapted business application software. Thus, the invention makes it possible that a customized business software application is not only generated automatically but also adapted, amended or altered according to changing requirements after a certain time. This is achieved by providing a set of meta data which can be customized by a user via input/output means such as a workbench and by processing said set of meta data through a generation tool according to the invention.

Still further, the invention provides for computer program products for generating business software applications and adapted business software applications, respectively, the computer program products comprising instructions to cause a processor of a computer to execute the steps according to the invention as described in more detail below.

### DESCRIPTION OF THE DRAWINGS

The detailed description will refer to the following drawing Figures in which like reference numerals refer to like objects. It is understood that the description is in no way limitative to the scope of the present invention and merely is an illustration of a preferred embodiment of the invention. Also, the described combination of the features of the invention is not be understood as a limitation, and all the features can be combined in other constellations without departing from the spirit of the invention. In the drawings,

FIG. 1 is a schematic view of a business application generation system according to the invention.

FIG. 2 is a schematic block diagram of the structure of the business application generation system according to the invention.

FIG. 3 is a flow chart depicting the method for generating a business software application according to the invention.

### DETAILED DESCRIPTION

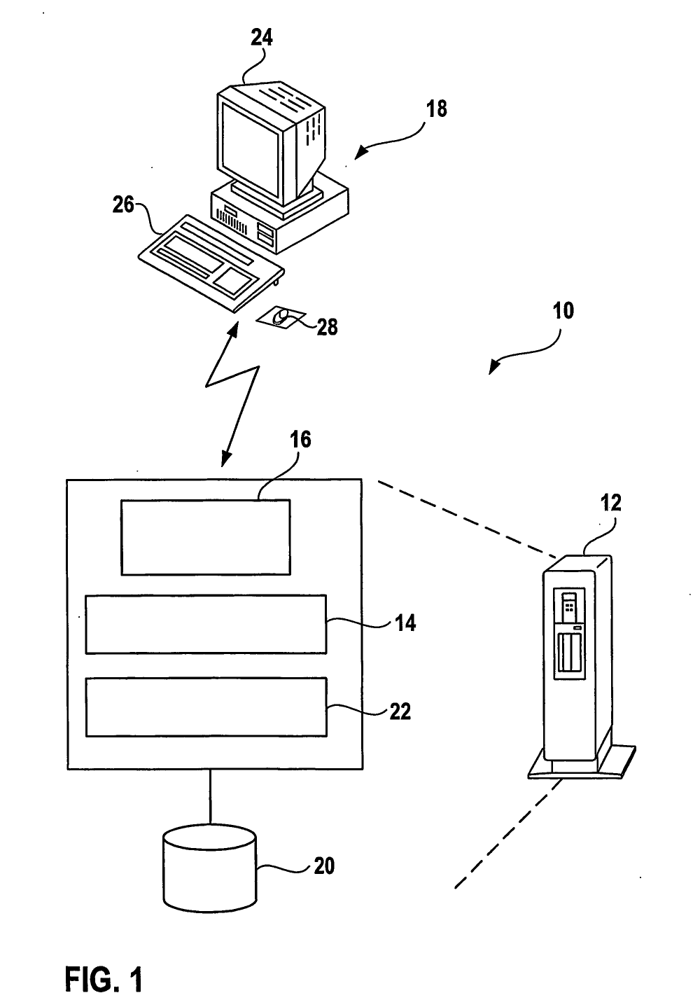

FIG. 1 shows a business application generation system 10 for automatically generating a business software application or an adapted business software application, respectively, according to the present invention. Computer system 10 comprises a server 12 with a central processing unit 14, an interface 16 for connection with at least one client is means 18, the client means advantageously comprising a monitor 24, a keyboard 26 and cursor control means (mouse or trackball) 28. The computer system 10 further comprises at least one data base means or repository 20 containing a set of meta data as well as a generation tool 22.

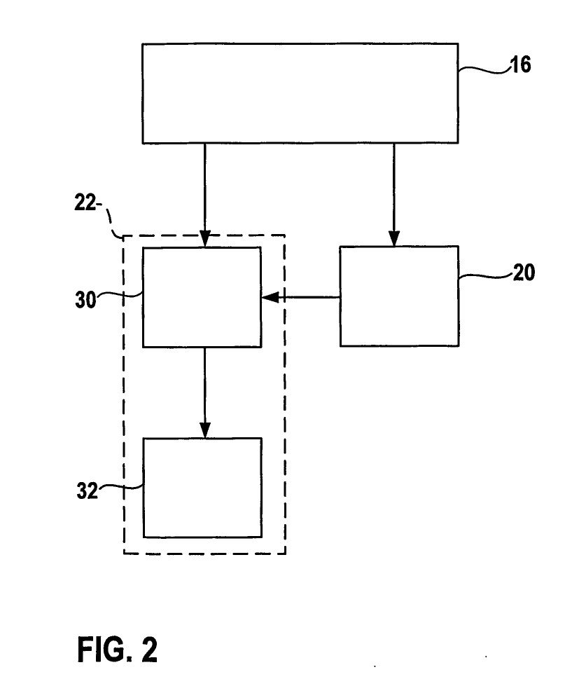

Referring now to FIG. 2, the structure of the business application generation system according to the invention is described in more detail. The business application generation system comprises said interface 16, said generation tool 22 and said repository 20. In the preferred embodiment of the invention as described herein below, the interface 16 advantageously is a workbench module which enables a user of the system to treat meta data contained in the repository 20 via input/output means 18, i.e. the workbench module 16 constitutes the interface between the system according to the invention and a user, the user acting on the workbench 16 via hardware input/output means 18.

The generation tool 22 preferably consists of a first tool and a second tool, the first tool being a passer element 30 which is dependent on the meta data contained in the repository 20 and the second tool being a generating element 32 which is independent of the meta data contained in the repository 20.

The repository 20 contains, as already mentioned above, a set of meta data containing structured information on the business process which is object of the software application to be generated. For example, the meta data contains structured information describing the structure of the business software application to be generated and which is considered upon automatic generation of the software application. By means of example only, the meta data may contain such information as data base tables and according structural definitions and table types for processing purposes, object type descriptions, function descriptions and function group descriptions, feature attributes (which may be used in templates) as well as information relating to client oriented base data and customized data, and flexible interface data, the latter enabling the generation of a software application that might be used in an open application or system environment.

The arrows depicted in the block diagram of FIG. 2 indicate the way certain modules of the invention make use of other modules. Via workbench 16, a user can access the meta data contained in repository 20 in order to treat said meta data. By the term “treat” in the context of this invention, any kind of viewing, creating, adding, deleting, changing, inheriting, addicting, etc. of the repository meta data is to be understood. As a consequence, a user is able to adapt or customize the meta data according to his needs. In order to simplify this task as much as possible, the workbench module 16 comprises interface surfaces providing a treatment of the meta data via easy to handle drag and drop techniques.

Via workbench 16, the user also invokes the generation tool 22. Preferably, invocation of the generation tool 22 is started by initiating an import of a customized set of meta data from the repository 20 into the passer element 30 of the generation tool 22.

In the passer element 30, the imported customized meta data is processed for further input into the generating element 32. By the term “process” in the context of this invention, any kind of handling, interpreting, preparing and conditioning of data is to be understood. In other words the passer element 30 gathers all the data and information that is needed by the generating element 32, interprets the semantical content of the meta data and translate the same into the technical information required by the generating element, and passes the result of the data processing as described on to the generating element 32.

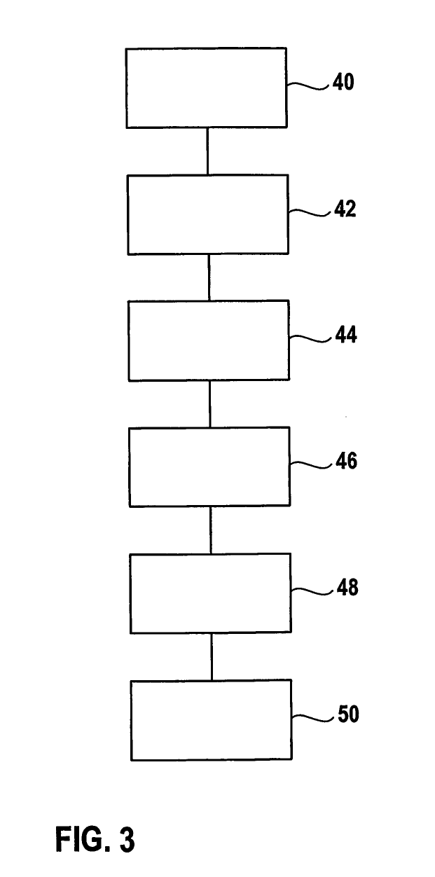

Referring now to FIG. 3, the method for generating a business software application according to the invention is described in more detail. FIG. 3 shows a flowchart illustrating the method of generating a business application in which, at 40, a set of meta data is provided, the set of meta data containing information on the business process data to be processed by the application to be generated and on functions operating on said business process data. In a preferred embodiment of the invention, the business process which is an object of the software application to be generated is a billing process.

If necessary, the set of meta data can be customized by a user via an input/output means, which is depicted at 42. As a next step, at 44, the meta data is imported into a generation tool, followed by a step of treating the meta data at 46, i.e. the meta data is interpreted, translated and processed into technical information data. This is preferably performed by a first tool of the generation tool which is a so called passer element. The passer element then inputs the processed data into a generating element of the generation tool at 48. Finally, the generating element generates a software application on the basis of the inputted data.

The step of generating the business software application depicted at 50 can either be the generation of a new business process application or it can be the generation of an adapted or amended version of an existing business process application. The latter is achieved, for example, when a user or client continually maintains and updates and amends the set of meta data stored in the repository of the system according to the invention in order to be able to create new versions of his business process application by running the method according to the present invention. For example, if a new client requirement arises, which could be for example introduction of bundle billing in a business billing process, and this new requirement is not yet provided by the user's billing application, the user might amend the set of meta data to include provisions for bundle billing and then, by re-running the method and software according to the invention, generate an updated version office billing application which includes a bundle billing process.

Thus, the invention provides a novel and advantageous business application generation system comprising a set of tools by means of which a user is able to create and adapt business software applications. This is achieved by providing a set of meta data which contains data, templates, allocation and name tables etc. to generate a software application supporting business processes which can preferably be run in existing software environments. It is an advantage of the invention that, due to the semantic information contained in the set of meta data, a user can generate a software application which is readily integrated in existing software environment. By customizing the set of meta data, it is possible to add customer specific fields to interfaces an database tables and define customer specific requirements such as selections for billing due list and billing documents.

1. A business application generation system for automatically generating a business software application, comprising:
a central processing unit;
a repository containing a set of meta data;
a generation tool; and
input/output means for treating said meta data and for invoking said generation tool;
said set of meta data containing structured business process application information comprising information on functions operating on business data, and said generation tool retrieving data from said repository and, on the basis of said retrieved repository data, generating a customized business process application.

2. The system according to claim 1, wherein said generation tool comprises a first tool and a second tool, said first tool being a meta data dependent passer element and said second tool being a meta data independent generating element.

3. The system according to claim 1, wherein said set of meta data consists of data base tables containing meta data entities.

4. The system according to claim 3, wherein said meta data entities contain information on the identification of an application to be generated, on object types and on object structures.

5. The system according to claim 4, wherein said object types contain information on the business process data to be processed by the application to be generated and on functions operating on said business process.

6. The system according to claim 1, wherein said business process is a billing process.

7. The system according to claim 1, wherein said business process is a bonus payment process.

8. The system according to claim 1, wherein said business process is a commission payment process.

9. The system according to claim 1, wherein said input/output means is a workbench enabling at least one of viewing, creating, adding, deleting, changing, inheriting, and editing of said repository meta data.

10. The system according to claim 2, wherein said input/output means is a workbench enabling the invocation of said generation tool by initiating an import of meta data into said passer element.

11. The system according to claim 2, wherein said passer element handles, interprets, and processes said set of meta data for input to said generating element, said generating element generating, on the basis of said data input, program code for said business process application.

12. The system according to claim 11, wherein said generating element further generates data objects for said business process application.

13. The system according to claim 11, wherein said generating element further generates a data base for said business process application.

14. A method for generating a business software application, comprising:
providing a set of meta data containing information on the business process data to be processed by the application to be generated and on functions operating on said business process data, and
importing said set of meta data comprising information on functions into a generation tool comprising a meta data dependent passer element and a meta data independent generating element for generating a customized business software application.

15. A method according to claim 14, further comprising the step of customizing said set of meta data via an input/output means before said meta data is imported into said generation tool.

16. A method according to claim 15, further comprising the step of handling, interpreting, and processing said set of meta data imported into said generation tool in said meta data dependent passer element.

17. A method according to claim 16, further comprising the steps of inputting said set of meta data after processing in said passer element into said generating element, and generating program code for said business process application on the basis of said data input.

18. A computer program product comprising a computer readable medium, the computer readable medium comprising instructions for carrying out a method for generating a business software application, the method comprising:
importing a set of meta data comprising information on functions into a generation tool, said generation tool comprising a meta data dependent passer element and a meta data independent generating element, and
on the basis of said set of meta data, processing meta data in said passer element, inputting said processed meta data in said generating element and generating a customized business software application.

19. (canceled)

20. A business application generation system for automatically adapting a business software application, comprising:
a central processing unit;
a repository containing a set of meta data;
a generation tool; and
input/output means for treating said meta data and for invoking said generation tool;
said set of meta data containing structured business process application information comprising information on functions operating on business data, and said generation tool retrieving data from said repository and, on the basis of said retrieved repository data, generating a customized adapted version of an existing business process application.

21. The system according to claim 20, wherein said generation tool comprises a first tool and a second tool, said first tool being a meta data dependent passer element and said second tool being a meta data independent generating element.

22. The system according to claim 20, wherein said set of meta data consists of data base tables containing meta data entities.

23. The system according to claim 22, wherein said meta data entities contain information on the identification of an application to be generated, on object types and on object structures.

24. The system according to claim 23, wherein said object types contain information on the business process data to be processed by the application to be generated and on functions operating on said business process.

25. The system according to claim 20, wherein said business process is a billing process.

26. The system according to claim 20, wherein said business process is a bonus payment process.

27. The system according to claim 20, wherein said business process is a commission payment process.

28. The system according to claim 20, wherein said input/output means is a workbench enabling at least one of viewing, creating, adding, deleting, changing, inheriting, and editing of said repository meta data.

29. The system according to claim 21, wherein said input/output means is a workbench enabling the invocation of said generation tool by initiating an import of meta data into said passer element.

30. The system according to claim 21, wherein said passer element handles, interprets, and processes said set of meta data for input to said generating element, said generating element generating, on the basis of said data input, program code for said business process application 30.

31. The system according to claim 30, wherein said generating element further generates data objects for said business process application.

32. The system according to claim 30, wherein said generating element further generates a data base for said business process application.

33. A method for generating an adapted business software application, comprising:
providing a set of meta data containing information on the business process data to be processed by the adapted application to be generated and on functions operating on said business process data, and
importing said set of meta data comprising information on functions into a generation tool comprising a meta data dependent passer element and a meta data independent generating element for generating a customized adapted business software application.

34. A method according to claim 33, further comprising the step of customizing said set of meta data via an input/output means before said meta data is imported into said generation tool.

35. A method according to claim 34, further comprising the step of handling, interpreting, and processing said set of meta data imported into said generation tool in said meta data dependent passer element.

36. A method according to claim 35, further comprising the steps of inputting said set of meta data after processing in said passer element into said generating element, and generating program code for said business process application on the basis of said data input.

37. A computer program product comprising a computer readable medium, the computer readable medium comprising instructions for carrying out a method for generating an adapted business software application, the method comprising:
importing a set of meta data into a generation tool, said generation tool comprising a meta data dependent passer element and a meta data independent generating element, and
on the basis of said set of meta data, processing meta data in said passer element, inputting said processed meta data in said generating element and generating a customized adapted business software application.

38. (canceled)
